(19) United States
(12) Patent Application Publication
(10) Pub. No.: US 2012/0112643 A1
(43) Pub. Date: May 10, 2012

(54) LIGHT-EMITTING DIODE LAMP WITH MULTI-CHANNEL CONSTANT-VOLTAGE AND CONSTANT-CURRENT CONTROL

(75) Inventor: Chia-Chieh LIN, Taipei Hsien (TW)

(73) Assignee: Chicony Power Technology Co., Ltd.

(21) Appl. No.: 12/940,141

(22) Filed: Nov. 5, 2010

(51) Int. Cl. H05B 37/02

(52) U.S. Cl. 315/185 R

(57) ABSTRACT

A light-emitting diode lamp with multi-channel constant-voltage and constant-current control is disclosed. The light-emitting diode lamp includes a constant-current controller, a feedback controller, a constant-voltage controller, a plurality of light-emitting diode apparatuses, a plurality of first feedback components, and a plurality of second feedback components. The constant-current controller, the feedback controller, and the constant-voltage controller are used to process current signals and voltage signals fed back from the light-emitting diode apparatuses to provide an adaptive multi-channel constant-voltage and constant-current control, thus increasing overall efficiency and operation flexibility of the light-emitting diode lamp under the alternating current or direct current power supply.

### BACKGROUND OF THE INVENTION

1. Field of the Invention

The present invention relates to a light-emitting diode lamp, and more particularly to a light-emitting diode lamp with multi-channel constant-voltage and constant-current control.

2. Description of Prior Art

For many years, light-emitting diodes (LEDs) play an important role in the backlight of portable electronic products. In the lighting application, LEDs are the most crucial components in the solid-state lighting industry. The advantages of LEDs include: energy saving, long life-span, free of maintenance, and so on. In addition, a well-matched driving circuit for driving LEDs is very necessary in the lighting, the backlight, or the display fields.

However, the current flows pass through the LEDs of the LED lamp may not be exactly identical due to somewhat different inner resistances of the LEDs when the LED lamp is driven through a voltage source. In addition, because the illuminating brightness of each LED is proportional to the forward current thereof, the above-mentioned problem would cause different illuminating brightness. Hence, overall efficiency of the LED lamp would decrease.

Accordingly, it is desirable to provide a light-emitting diode lamp with multi-channel constant-voltage and constant-current control to increase overall efficiency and operation flexibility of the light-emitting diode lamp under the alternating current or direct current power supply.

### SUMMARY OF THE INVENTION

In order to achieve the above-mentioned objectives, a light-emitting diode lamp with multi-channel constant-voltage and constant-current control is disclosed. The light-emitting diode lamp includes a constant-current controller, a feedback controller, a constant-voltage controller, a plurality of light-emitting diode apparatuses, a plurality of first feedback components, and a plurality of second feedback components.

The feedback controller is electrically connected to the constant-current controller and the constant-voltage controller is electrically connected o the feedback controller.

Each of the light-emitting diode apparatuses includes a light-emitting diode lamp string, a power switch, and a constant-current source. Each light-emitting diode lamp string is composed of a plurality of in-series light-emitting diodes and each light-emitting diode lamp string has a first terminal and a second terminal. Each of the first terminals of the light-emitting diode lamp strings is electrically connected to each other and electrically connected to the constant-voltage controller. Each power switch has a first terminal, a second terminal, and a third terminal. The first terminal of the power switch is electrically connected to the second terminal of the light-emitting diode lamp string. Each of the third terminals of the power switches is electrically connected to each other and electrically connected to the constant-current controller and the feedback controller, respectively. Each constant-current source has a first terminal and a second terminal. The first terminal of the constant-current source is electrically connected to the second terminal of the power switch and the second terminal of the constant-current source is grounded.

Each of the first feedback components has a first terminal and a second terminal. Each first terminal of the first feedback component is electrically connected to the corresponding second terminal of the light-emitting diode lamp string and the first terminal of the power switch. Each second terminal of the first feedback component is electrically connected to each other and electrically connected to the feedback controller through a first feedback path.

Each of the second feedback components has a first terminal and a second terminal. Each first terminal of the second feedback component is electrically connected to the corresponding second terminal of power switch and the first terminal of the constant-current source. Each second terminal of the second feedback component is electrically connected to each other and electrically connected to the constant-current controller through a first feedback path.

Therefore, the adaptive multi-channel constant-voltage and constant-current control is provided to increase overall efficiency and operation flexibility of the light-emitting diode lamp under the alternating current or direct current power supply.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a circuit block diagram of a light-emitting diode lamp with multi-channel constant-voltage and constant-current control according to a first embodiment of the present invention; and

FIG. 2 is a circuit block diagram of the light-emitting diode lamp with multi-channel constant-voltage and constant-current control according to a second embodiment of the present invention.

### DETAILED DESCRIPTION OF THE INVENTION

Reference will now be made to the drawing figures to describe the present invention in detail.

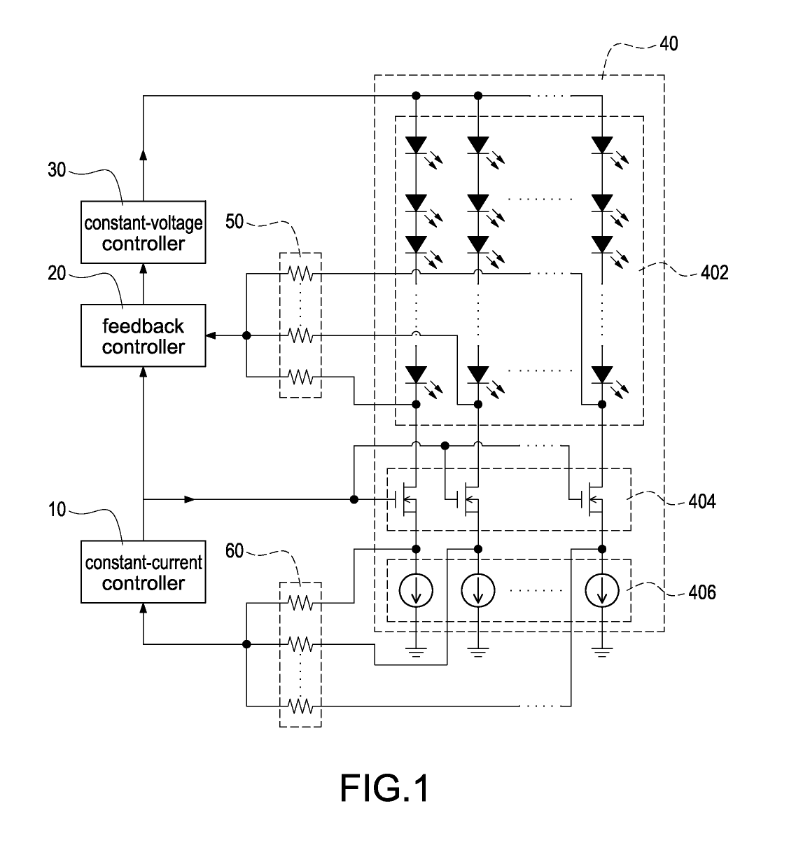

Reference is made to FIG. 1 which is a circuit block diagram of a light-emitting diode lamp with multi-channel constant-voltage and constant-current control according to a first embodiment of the present invention. The light-emitting diode lamp includes a constant-current controller 10, a feedback controller 20, a constant-voltage controller 30, a plurality of light-emitting diode apparatuses 40, a plurality of first feedback components 50, and a plurality of second feedback components 60.

The feedback controller 20 is electrically connected to the constant-current controller 10. The constant-voltage controller 30 is electrically connected to the feedback controller 20.

Each of the light-emitting diode apparatuses includes a light-emitting diode lamp string 402, a power switch 404, and a constant-current source 406. In particular, each of the power switches 404 is a metal-oxide-semiconductor field-effect transistor (MOSFET). Furthermore, each of the power switches 404 can be a transistor. The power switches 404 are controlled by using a pulse width modulation (PWM) technology when the power switches 404 are the MOSFETs. In addition, the power switches are controlled by using a pulse width modulation (PWM) technology or a square-wave voltage when the power switches are the transistors.

Each light-emitting diode lamp string 402 is composed of a plurality of in-series light-emitting diodes and each light-emitting diode lamp string 402 has a first terminal (not labeled) and a second terminal (now labeled). Each of the first terminals of the light-emitting diode lamp strings 402 is electrically connected to each other and electrically connected to the constant-voltage controller 30.

Each power switch 404 has a first terminal (not labeled), a second terminal (not labeled), and a third terminal (not labeled). The first terminal of the power switch 404 is electrically connected to the second terminal of the light-emitting diode lamp string 402. Each of the third terminals of the power switches 404 is electrically connected to each other and electrically connected to the constant-current controller 10 and the feedback controller 20, respectively. In this embodiment, the MOSFETs are exemplified for further demonstration. The first terminal, the second terminal, and the third terminal of the power switch 404 are a drain, a source, and a gate, respectively. The first terminal (drain) of the power switch 404 is electrically connected to the second terminal (the cathode of the last in-series light-emitting diode) of the light-emitting diode lamp string 402. Each of the third terminals (gates) of the power switch 404 is electrically connected to each other and electrically connected to the constant-current controller 10 and the feedback controller 20, respectively. Hence, a feedback control path is formed between each of the third terminals of the power switches 404 and the constant-current controller 10 and the feedback controller 20.

Each constant-current source 406 has a first terminal (not labeled) and a second terminal (not labeled). The first terminal of the constant-current source 406 is electrically connected to the second terminal (source) of the power switch 404 and the second terminal of the constant-current source is grounded.

Each of the first feedback components 50 has a first terminal (not labeled) and a second terminal (not labeled). Each first terminal of the first feedback component 50 is electrically connected to the corresponding second terminal of the light-emitting diode lamp string 402 and the first terminal of the power switch 404. Each second terminal of the first feedback component 50 is electrically connected to each other and electrically connected to the feedback controller 20 through a first feedback path. Hence, the first feedback path is formed between each of the first terminals of the power switches 404 and the feedback controller 20. In this embodiment, each of the first feedback components 50 is a resistor.

Each of the second feedback components 60 has a first terminal (not labeled) and a second terminal (not labeled). Each first terminal of the second feedback component 60 is electrically connected to the corresponding second terminal of the power switch 404 and the first terminal of the constant-current source 406. Each second terminal of the second feedback component 60 is electrically connected to each other and electrically connected to the constant-current controller 10 through a second feedback path. Hence, the second feedback path is formed between each of the second terminals of the power switches 404 and the constant-current controller 10. In this embodiment, each of the second feedback components 60 is a resistor.

The detailed description of the light-emitting diode lamp with multi-channel constant-voltage and constant-current control will be made hereinafter. The constant-voltage controller 30 provides a driving voltage to drive the light-emitting diode apparatuses 40. The driving voltage is provided to light the in-series light-emitting diodes of the light-emitting diode lamp strings 402 when the power switches 404 is turned on. In addition, the constant-current source 406 is used to adjust illuminating brightness of the light-emitting diodes.

In particular, the amount of the first feedback components 50 is the same as that of the light-emitting diode lamp strings 402, further the first feedback components 50 are corresponding to the light-emitting diode lamp strings 402. The voltage signals, according to the voltage differences between the first terminals (drains) of the power switches 404 and the ground, are fed back to the feedback controller 20 through the corresponding first feedback components 50 of the first feedback path.

Similarly, the amount of the second feedback components 60 is the same as that of the light-emitting diode lamp strings 402, further the second feedback components 60 are corresponding to the light-emitting diode lamp strings 402. The current signals, according to the current flows from the second terminals (sources) of the power switches 404 to the constant-current source 406, are fed back to the constant-current controller 10 through the corresponding second feedback components 60 of the second feedback path. In addition, the constant-current controller 10 sums up the current signals fed from the second feedback path. Afterward, the summed current signals are sent by the constant-current controller 10 to the feedback controller 20 and the power switches 404, respectively. In particular, the third terminals (gates) of the power switches 404 are controlled by the summed current signals to realize the constant-current control, thus maintaining illuminating brightness of the in-series light-emitting diodes according the identical current flow.

The feedback controller 20 simultaneously receives the current signals, which are sent from the constant-current controller 10, and the voltage signals, which are sent from the first feedback path. The feedback controller 20 integrates the current signals and the voltage signals to output a voltage signal to the constant-voltage controller 30. Therefore, the constant-voltage controller 30 adjusts the output voltage of a driver to provide an adaptive constant-voltage control to the light-emitting diode lamp strings 402, thus increasing the conversion efficiency.

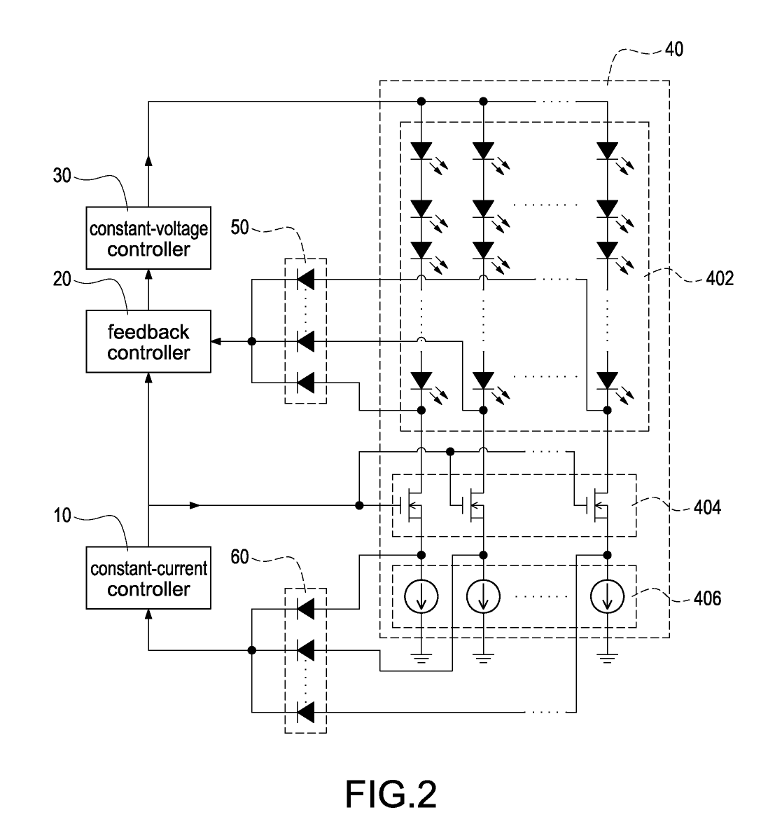

Reference is made to FIG. 2 which is a circuit block diagram of the light-emitting diode lamp with multi-channel constant-voltage and constant-current control according to a second embodiment of the present invention. The circuit structure of this embodiment is the same as that of the first embodiment. However, the difference between the two embodiments is that the first feedback components 50 and the second feedback components 60 are both diodes, but the rest is the same. Hence, the detail description is omitted here for conciseness. Because the first feedback components 50 and the second feedback components 60 are the resistors and the diodes, respectively, the first feedback path and the second feedback path can pass though both the direct current signals and the alternating current signals, thus increasing operation flexibility of the light-emitting diode lamp under the alternating current or direct current power supply.

Accordingly, the constant-current controller, the feedback controller, and the constant-voltage controller are used to process the current signals and voltage signals fed back from the light-emitting diode apparatuses to provide an adaptive multi-channel constant-voltage and constant-current control, thus increasing overall efficiency and operation flexibility of the light-emitting diode lamp under the alternating current or direct current power supply.

In conclusion, the present invention has following advantages:

1. The light-emitting diode lamp is controlled by multi-channel constant-voltage and constant-current control to increase overall efficiency and operation flexibility thereof.

2. Because the first feedback components and the second feedback components are the resistors and the diodes, respectively, the light-emitting diode lamp can be controlled under the alternating current or direct current power supply.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A light-emitting diode lamp with multi-channel constant-voltage and constant-current control comprising:
a constant-current controller;
a feedback controller electrically connected to the constant-current controller;
a constant-voltage controller electrically connected to the feedback controller;
a plurality of light-emitting diode apparatuses, and each light-emitting diode apparatus comprising:
a light-emitting diode lamp string composed of a plurality of in-series light-emitting diodes; and each light-emitting diode having a first terminal and a second terminal; each of the first terminals of the light-emitting diode lamp strings electrically connected to each other and electrically connected to the constant-voltage controller;
a power switch having a first terminal, a second terminal, and a third terminal, and the first terminal of the power switch electrically connected to the second terminal of the light-emitting diode lamp string; each of the third terminals of the power switches electrically connected to each other and electrically connected to the constant-current controller and the feedback controller, respectively;
a constant-current source having a first terminal and a second terminal, the first terminal of the constant-current source electrically connected to the second terminal of the power switch and the second terminal of the constant-current source grounded;
a plurality of first feedback components, each of the first feedback components having a first terminal and a second terminal; each first terminal of the first feedback component electrically connected to the corresponding second terminal of the light-emitting diode lamp string and the first terminal of the power switch; each second terminal of the first feedback component electrically connected to each other and electrically connected to the feedback controller through a first feedback path;
a plurality of second feedback components, each of the second feedback components having a first terminal and a second terminal; each first terminal of the second feedback component electrically connected to the corresponding second terminal of the power switch and the first terminal of the constant-current source; each second terminal of the second feedback component electrically connected to each other and electrically connected to the constant-current controller through a second feedback path;
whereby the adaptive multi-channel constant-voltage and constant-current control is provided to increase overall efficiency and operation flexibility of the light-emitting diode lamp under the alternating current or direct current power supply.

2. The light-emitting diode lamp in claim 1, wherein each of the first feedback components and each of the second feedback components is a resistor, respectively.

3. The light-emitting diode lamp in claim 1, wherein each of the first feedback components and each of the second feedback components is a diode, respectively.

4. The light-emitting diode lamp in claim 1, wherein each of the power switches is a metal-oxide-semiconductor field-effect transistor (MOSFET).

5. The light-emitting diode lamp in claim 1, wherein each of the power switches is a transistor.

6. The light-emitting diode lamp in claim 4, wherein the power switches are controlled by using a pulse width modulation (PWM) technology when the power switches are the MOSFETs.

7. The light-emitting diode lamp in claim 5, wherein the power switches are controlled by using a pulse width modulation (PWM) technology or a square-wave voltage when the power switches are the transistors.
